(19) United States
(12) Patent Application Publication
(10) Pub. No.: US 2024/0389020 A1
(43) Pub. Date: Nov. 21, 2024

(54) FEEDBACK DURING CELL DISCONTINUOUS TRANSMISSION OPERATION

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/417,923

(22) Filed: Jan. 19, 2024

Related U.S. Application Data
(60) Provisional application No. 63/503,131, filed on May 18, 2023.

(51) Int. Cl. H04W 52/02; H04W 72/11; H04W 76/28

(52) U.S. Cl. CPC H04W 52/0216; H04W 52/0229; H04W 72/11; H04W 76/28

(57) ABSTRACT

Methods, systems, and devices for wireless communications are described. A user equipment (UE) may monitor a set of semi-persistent scheduling (SPS) occasions associated with downlink transmissions from a network entity, wherein a first subset of SPS occasions overlaps in a time domain with an active period of a discontinuous transmission (DTX) cycle of the network entity and a second subset of SPS occasions overlaps in the time domain with an inactive period of the DTX cycle. The UE may selectively perform or drop a feedback transmission associated with the monitoring based at least in part on the overlap between the second subset of SPS occasions and the inactive period of the DTX cycle.

### CROSS REFERENCE

The present application for patent claims the benefit of U.S. Provisional Patent Application No. 63/503,131 by Abotabl et al., entitled “FEEDBACK DURING CELL DISCONTINUOUS TRANSMISSION OPERATION,” filed May 18, 2023, assigned to the assignee hereof, and expressly incorporated by reference herein.

### FIELD OF TECHNOLOGY

The following relates to wireless communications, including feedback during cell discontinuous transmission operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support feedback during cell discontinuous transmission (DTX) operation. For example, the described techniques provide mechanisms to improve DTX and/or discontinuous reception (DRX) scheduling and alignment within a wireless network. For example, and for DTX, a user equipment (UE) may be configured with a set of semi-persistent scheduling (SPS) resources during corresponding SPS occasions (e.g., SPS monitoring occasions when the UE monitors for downlink transmissions via the SPS resources). The UE may monitor the set of SPS occasions associated with downlink transmissions from a network entity. However, a first subset of the SPS occasions may overlap in the time domain with an active period of a DTX cycle of the network entity. A second subset of the SPS occasions may overlap in the time domain with an inactive period of the DTX cycle of the network entity. That is, the SPS occasions may span active and inactive periods of the DTX cycle. Accordingly, the UE may selectively perform or drop a feedback transmission associated with the monitoring based at least in part on the overlap between the second subset of SPS occasions and the inactive period of the DTX cycle.

Additionally, or alternatively, the UE may selectively monitor for a downlink control information (DCI) message associated with activating or deactivating the DTX cycle of the network entity. The DCI message may be a UE-specific DCI message and/or a group common DCI. The UE may communicate with the network entity according to the DTX cycle based at least in part on the selective monitoring.

A method for wireless communications at a UE is described. The method may include monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle and selectively performing or dropping a feedback transmission associated with the monitoring based on the overlap between the second subset of SPS occasions and the inactive period of the DTX cycle.

An apparatus for wireless communications at a UE is described. The apparatus may include one or more processors, one or more memories coupled with the one or more processors, and instructions stored in the one or more memories. The instructions may be executable by the one or more processors to cause the apparatus to monitor a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle and selectively perform or drop a feedback transmission associated with the monitoring based on the overlap between the second subset of SPS occasions and the inactive period of the DTX cycle.

Another apparatus for wireless communications at a UE is described. The apparatus may include means for monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle and means for selectively performing or dropping a feedback transmission associated with the monitoring based on the overlap between the second subset of SPS occasions and the inactive period of the DTX cycle.

A non-transitory computer-readable medium storing code for wireless communications at a UE is described. The code may include instructions executable by one or more processors to monitor a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle and selectively perform or drop a feedback transmission associated with the monitoring based on the overlap between the second subset of SPS occasions and the inactive period of the DTX cycle.

In some examples of the method, apparatuses, and non-transitory computer-readable medium described herein, selectively performing or dropping the feedback transmission may include operations, features, means, or instructions for dropping the feedback transmission based on the overlap between the second subset of SPS occasions and the inactive period.

In some examples of the method, apparatuses, and non-transitory computer-readable medium described herein, selectively performing or dropping the feedback transmission may include operations, features, means, or instructions for dropping the feedback transmission based on a numerical quantity of SPS occasions in the first subset of SPS occasions overlapping with the active period of the DTX cycle failing to satisfy a threshold.

In some examples of the method, apparatuses, and non-transitory computer-readable medium described herein, selectively performing or dropping the feedback transmission may include operations, features, means, or instructions for performing the feedback transmission based on the overlap between the first subset of SPS occasions and the active period of the DTX cycle, the feedback transmission performed after a last SPS occasion.

In some examples of the method, apparatuses, and non-transitory computer-readable medium described herein, the last SPS occasion includes a sequentially last scheduled SPS occasion in the set of SPS occasions.

In some examples of the method, apparatuses, and non-transitory computer-readable medium described herein, the last SPS occasion includes a last SPS occasion of the first subset of SPS occasions overlapping with the active period of the DTX cycle.

In some examples of the method, apparatuses, and non-transitory computer-readable medium described herein, selectively performing or dropping the feedback transmission may include operations, features, means, or instructions for performing the feedback transmission during an uplink occasion occurring during the second subset of SPS occasions based on a third subset of SPS occasions in the set of SPS occasions scheduled during a second active period of the DTX cycle, the second active period following the inactive period of the DTX cycle in the time domain.

Some examples of the method, apparatuses, and non-transitory computer-readable medium described herein may further include operations, features, means, or instructions for performing the feedback transmission may be based on a numerical quantity of SPS occasions in the first subset of SPS occasions, a time offset between the uplink occasion and a start of the second active period, or both.

A method for wireless communications at a UE is described. The method may include selectively monitoring, based on an active period of a DTX cycle of a network entity, for a DCI message associated with activating or deactivating the DTX cycle of a network entity, the DCI message including a group common DCI message, and communicating with the network entity according to the DTX cycle based on the selectively monitoring.

An apparatus for wireless communications at a UE is described. The apparatus may include one or more processors, one or more memories coupled with the one or more processors, and instructions stored in the one or more memories. The instructions may be executable by the one or more processors to cause the apparatus to selectively monitor, based on an active period of a DTX cycle of a network entity, for a DCI message associated with activating or deactivating the DTX cycle of a network entity, the DCI message including a group common DCI message, and communicate with the network entity according to the DTX cycle based on the selectively monitoring.

Another apparatus for wireless communications at a UE is described. The apparatus may include means for selectively monitoring, based on an active period of a DTX cycle of a network entity, for a DCI message associated with activating or deactivating the DTX cycle of a network entity, the DCI message including a group common DCI message, and means for communicating with the network entity according to the DTX cycle based on the selectively monitoring.

A non-transitory computer-readable medium storing code for wireless communications at a UE is described. The code may include instructions executable by one or more processors to selectively monitor, based on an active period of a DTX cycle of a network entity, for a DCI message associated with activating or deactivating the DTX cycle of a network entity, the DCI message including a group common DCI message, and communicate with the network entity according to the DTX cycle based on the selectively monitoring.

In some examples of the method, apparatuses, and non-transitory computer-readable medium described herein, the selectively monitoring may include operations, features, means, or instructions for monitoring for the DCI message during the active period of the DTX cycle.

In some examples of the method, apparatuses, and non-transitory computer-readable medium described herein, the selectively monitoring may include operations, features, means, or instructions for monitoring for the group common DCI message outside of the active period and during an inactive period of the DTX cycle.

In some examples of the method, apparatuses, and non-transitory computer-readable medium described herein, the selectively monitoring may include operations, features, means, or instructions for refraining from monitoring for the DCI message during one or more monitoring occasions occurring outside of the active period and during an inactive period of the DTX cycle.

Some examples of the method, apparatuses, and non-transitory computer-readable medium described herein may further include operations, features, means, or instructions for receiving a signal indicating that the UE may be to refrain from monitoring for the DCI message during one or more monitoring occasions occurring outside of the active period and during an inactive period of the DTX cycle.

Some examples of the method, apparatuses, and non-transitory computer-readable medium described herein may further include operations, features, means, or instructions for transmitting a UE capability message indicating support for activating or deactivating the DTX cycle via the DCI message.

In some examples of the method, apparatuses, and non-transitory computer-readable medium described herein, the support includes support for refraining from monitoring for the DCI message outside of the active period and during an inactive period of the DTX cycle.

A method for wireless communications at a network entity is described. The method may include performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle and selectively receiving or dropping a feedback transmission from the UE associated with the one or more downlink transmissions based on the overlap between the second subset of SPS occasions and the inactive period of the DTX cycle.

An apparatus for wireless communications at a network entity is described. The apparatus may include one or more processors, one or more memories coupled with the one or more processors, and instructions stored in the one or more memories. The instructions may be executable by the one or more processors to cause the apparatus to perform, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle and selectively receive or drop a feedback transmission from the UE associated with the one or more downlink transmissions based on the overlap between the second subset of SPS occasions and the inactive period of the DTX cycle.

Another apparatus for wireless communications at a network entity is described. The apparatus may include means for performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle and means for selectively receiving or dropping a feedback transmission from the UE associated with the one or more downlink transmissions based on the overlap between the second subset of SPS occasions and the inactive period of the DTX cycle.

A non-transitory computer-readable medium storing code for wireless communications at a network entity is described. The code may include instructions executable by one or more processors to perform, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle and selectively receive or drop a feedback transmission from the UE associated with the one or more downlink transmissions based on the overlap between the second subset of SPS occasions and the inactive period of the DTX cycle.

In some examples of the method, apparatuses, and non-transitory computer-readable medium described herein, selectively receiving or dropping the feedback transmission may include operations, features, means, or instructions for dropping the feedback transmission based on the overlap between the second subset of SPS occasions and the inactive period.

In some examples of the method, apparatuses, and non-transitory computer-readable medium described herein, selectively receiving or dropping the feedback transmission may include operations, features, means, or instructions for dropping the feedback transmission based on a numerical quantity of SPS occasions in the first subset of SPS occasions overlapping with the active period of the DTX cycle failing to satisfy a threshold.

In some examples of the method, apparatuses, and non-transitory computer-readable medium described herein, selectively receiving or dropping the feedback transmission may include operations, features, means, or instructions for receiving the feedback transmission based on the overlap between the first subset of SPS occasions and the active period of the DTX cycle, the feedback transmission performed after a last SPS occasion.

In some examples of the method, apparatuses, and non-transitory computer-readable medium described herein, the last SPS occasion includes a sequentially last scheduled SPS occasion in the set of SPS occasions.

In some examples of the method, apparatuses, and non-transitory computer-readable medium described herein, the last SPS occasion includes a last SPS occasion of the first subset of SPS occasions overlapping with the active period of the DTX cycle.

In some examples of the method, apparatuses, and non-transitory computer-readable medium described herein, selectively receiving or dropping the feedback transmission may include operations, features, means, or instructions for receiving the feedback transmission during an uplink occasion occurring during the second subset of SPS occasions based on a third subset of SPS occasions in the set of SPS occasions scheduled during a second active period of the DTX cycle, the second active period following the inactive period of the DTX cycle in the time domain.

Some examples of the method, apparatuses, and non-transitory computer-readable medium described herein may further include operations, features, means, or instructions for receiving the feedback transmission may be based on a numerical quantity of SPS occasions in the first subset of SPS occasions, a time offset between the uplink occasion and a start of the second active period, or both.

A method for wireless communications at a network entity is described. The method may include selectively transmitting, to a UE and based on an active period of a DTX cycle of the network entity, a DCI message associated with activating or deactivating the DTX cycle, the DCI message including a group common DCI message, and communicating with the UE according to the DTX cycle based on the selectively transmitting.

An apparatus for wireless communications at a network entity is described. The apparatus may include one or more processors, one or more memories coupled with the one or more processors, and instructions stored in the one or more memories. The instructions may be executable by the one or more processors to cause the apparatus to selectively transmit, to a UE and based on an active period of a DTX cycle of the network entity, a DCI message associated with activating or deactivating the DTX cycle, the DCI message including a group common DCI message, and communicate with the UE according to the DTX cycle based on the selectively transmitting.

Another apparatus for wireless communications at a network entity is described. The apparatus may include means for selectively transmitting, to a UE and based on an active period of a DTX cycle of the network entity, a DCI message associated with activating or deactivating the DTX cycle, the DCI message including a group common DCI message, and means for communicating with the UE according to the DTX cycle based on the selectively transmitting.

A non-transitory computer-readable medium storing code for wireless communications at a network entity is described. The code may include instructions executable by one or more processors to selectively transmit, to a UE and based on an active period of a DTX cycle of the network entity, a DCI message associated with activating or deactivating the DTX cycle, the DCI message including a group common DCI message, and communicate with the UE according to the DTX cycle based on the selectively transmitting.

In some examples of the method, apparatuses, and non-transitory computer-readable medium described herein, the selectively transmitting may include operations, features, means, or instructions for transmitting the DCI message during the active period of the DTX cycle.

In some examples of the method, apparatuses, and non-transitory computer-readable medium described herein, the selectively transmitting may include operations, features, means, or instructions for transmitting the group common DCI message outside of the active period and during an inactive period of the DTX cycle.

In some examples of the method, apparatuses, and non-transitory computer-readable medium described herein, the selectively transmitting may include operations, features, means, or instructions for refraining from transmitting the DCI message during one or more monitoring occasions occurring outside of the active period and during an inactive period of the DTX cycle.

Some examples of the method, apparatuses, and non-transitory computer-readable medium described herein may further include operations, features, means, or instructions for transmitting a signal indicating that the UE may be to refrain from monitoring for the DCI message during one or more monitoring occasions occurring outside of the active period and during an inactive period of the DTX cycle.

Some examples of the method, apparatuses, and non-transitory computer-readable medium described herein may further include operations, features, means, or instructions for receiving a UE capability message indicating support for activating or deactivating the DTX cycle via the DCI message.

In some examples of the method, apparatuses, and non-transitory computer-readable medium described herein, the support includes support for refraining from monitoring for the DCI message outside of the active period and during an inactive period of the DTX cycle.

### BRIEF DESCRIPTION OF THE DRAWINGS

FIG. 1 shows an example of a wireless communications system that supports feedback during cell discontinuous transmission (DTX) operation in accordance with one or more aspects of the present disclosure.

FIG. 2 shows an example of a wireless communications system that supports feedback during cell DTX operation in accordance with one or more aspects of the present disclosure.

FIG. 3 shows an example of an overlap configuration that supports feedback during cell DTX operation in accordance with one or more aspects of the present disclosure.

FIG. 4 shows an example of an overlap configuration that supports feedback during cell DTX operation in accordance with one or more aspects of the present disclosure.

FIGS. 5 and 6 show block diagrams of devices that support feedback during cell DTX operation in accordance with one or more aspects of the present disclosure.

FIG. 7 shows a block diagram of a communications manager that supports feedback during cell DTX operation in accordance with one or more aspects of the present disclosure.

FIG. 8 shows a diagram of a system including a device that supports feedback during cell DTX operation in accordance with one or more aspects of the present disclosure.

FIGS. 9 and 10 show block diagrams of devices that support feedback during cell DTX operation in accordance with one or more aspects of the present disclosure.

FIG. 11 shows a block diagram of a communications manager that supports feedback during cell DTX operation in accordance with one or more aspects of the present disclosure.

FIG. 12 shows a diagram of a system including a device that supports feedback during cell DTX operation in accordance with one or more aspects of the present disclosure.

FIGS. 13 through 16 show flowcharts illustrating methods that support feedback during cell DTX operation in accordance with one or more aspects of the present disclosure.

### DETAILED DESCRIPTION

Wireless networks may apply a discontinuous transmission (DTX) cycle and/or a discontinuous reception (DRX) cycles at a network entity and/or user equipment (UE) to conserve resources and power. Each cycle generally involves active periods of transmitting (or receiving) separated by inactive periods of refraining from transmitting (or receiving). While such techniques may be helpful, misalignment of active transmission and receiving periods between the network entity and UE creates waste and interrupts communications between the nodes of the wireless network. One non-limiting example of such consequences relates to semi-persistent resources allocated for transmitting or receiving by the UE. For example, monitoring occasions associated with semi-persistent downlink resources may be misaligned with the DTX cycle of the network entity, which means that some of the monitoring occasions fall within inactive periods of the DTX cycle. Furthermore, feedback information associated with the semi-persistent downlink resources may be scheduled to occur after a last monitoring occasion of the semi-persistent downlink resources, even when such occasions are unavailable for downlink transmissions according to the DTX cycle of the network entity. This scheduling may delay feedback reporting by the UE, which increases the processing and storage load of the UE in addition to creating unnecessary delays within the wireless network.

The described techniques relate to improved methods, systems, devices, and apparatuses that support feedback during cell DTX operation. For example, the described techniques provide mechanisms to improve DTX and/or discontinuous reception (DRX) scheduling and alignment within a wireless network. For example, and for DTX, a UE may be configured with a set of semi-persistent scheduling (SPS) resources during corresponding SPS occasions (e.g., SPS monitoring occasions when the UE monitors for downlink transmissions via the SPS resources). The UE may monitor the set of SPS occasions associated with downlink transmissions from a network entity. However, a first subset of the SPS occasions may overlap in the time domain with an active period of a DTX cycle of the network entity. A second subset of the SPS occasions may overlap in the time domain with an inactive period of the DTX cycle of the network entity. That is, the SPS occasions may span active and inactive periods of the DTX cycle. Accordingly, the UE may selectively perform or drop a feedback transmission associated with the monitoring based at least in part on the overlap between the second subset of SPS occasions and the inactive period of the DTX cycle.

Additionally, or alternatively, the UE may selectively monitor for a downlink control information (DCI) message associated with activating or deactivating the DTX cycle of the network entity. The DCI message may be a UE-specific DCI message and/or a group common DCI. The UE may communicate with the network entity according to the DTX cycle based at least in part on the selective monitoring.

Aspects of the disclosure are initially described in the context of wireless communications systems. Aspects of the disclosure are further illustrated by and described with reference to apparatus diagrams, system diagrams, and flowcharts that relate to feedback during cell DTX operation.

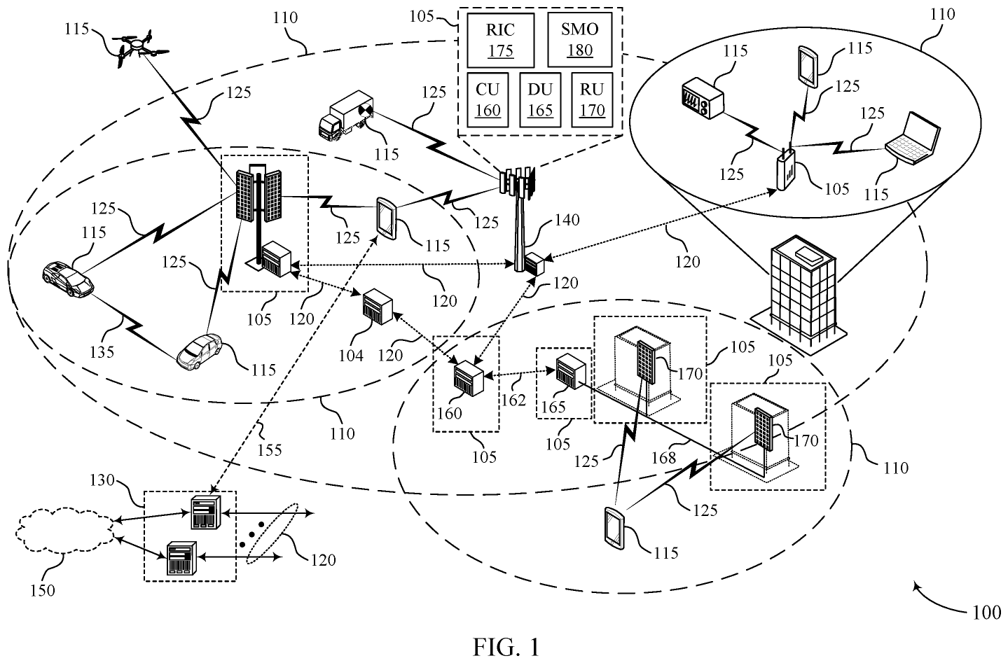

FIG. 1 shows an example of a wireless communications system 100 that supports feedback during cell DTX operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support feedback during cell DTX operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may monitor a set of SPS occasions associated with downlink transmissions from a network entity 105, where a first subset of SPS occasions overlaps in a time domain with an active period of a DTX cycle of the network entity 105 and a second subset of SPS occasions overlaps in the time domain with an inactive period of the DTX cycle. The UE 115 may selectively perform or drop a feedback transmission associated with the monitoring based at least in part on the overlap between the second subset of SPS occasions and the inactive period of the DTX cycle.

A UE 115 may selectively monitor, based at least in part on an active period of a DTX cycle of a network entity 105, for a DCI message associated with activating or deactivating the DTX cycle of the network entity 105, the DCI message including a UE-specific DCI message, a group common DCI message, or both. The UE 115 may communicate with the network entity 105 according to the DTX cycle based at least in part on the selective monitoring.

A network entity 105 may perform, during a set of SPS occasions of a UE 115, one or more downlink transmissions to the UE 115, where a first subset of SPS occasions overlaps in a time domain with an active period of a DTX cycle of the network entity 105 and a second subset of SPS occasions overlaps in the time domain with an inactive period of the DTX cycle. The network entity 105 may selectively receive or drop a feedback transmission from the UE 115 associated with the one or more downlink transmissions based at least in part on the overlap between the second subset of SPS occasions and the inactive period of the DTX cycle.

A network entity 105 may selectively transmit, to a UE 115 and based at least in part on an active period of a DTX cycle of the network entity 105, a DCI message associated with activating or deactivating the DTX cycle, the DCI message including a UE-specific DCI message, a group common DCI message, or both. The network entity 105 may communicate with the UE 115 according to the DTX cycle based at least in part on the selective transmitting.

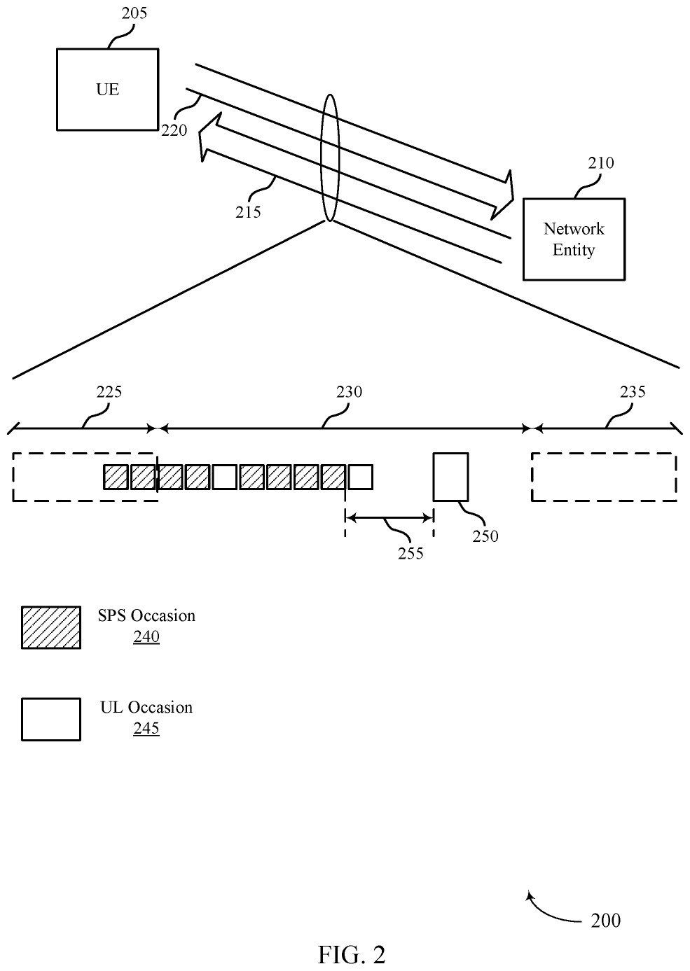

FIG. 2 shows an example of a wireless communications system 200 that supports feedback during cell DTX operation in accordance with one or more aspects of the present disclosure. Wireless communications system 200 may implement aspects of wireless communications system 100. Wireless communications system 200 may include a UE 205 and a network entity 210, which may be examples of the corresponding devices described herein.

Advances in wireless communication techniques often result in increased power consumption, resource utilization, more complex operations, and the like, for the nodes of the wireless network. Wireless networks may adopt various strategies to further conserve power and resources and to simplify and improve network complexity and performance. One example of such power conserving techniques includes DTX/DRX cycles implemented on the network side (e.g., at the network entity 210) and/or by the UE (e.g., by the UE 205). Such techniques generally define active and inactive periods where the device (e.g., the UE 205 and/or the network entity 210) is able to communicate (the active period(s)) or not able to communicate (the inactive period(s)). Wireless communications system 200 illustrates a non-limiting example of a DTX cycle consisting of an active period 225, an inactive period 230, which is followed by an active period 235 (e.g., a second active period). The active/inactive periods may repeat a number of times corresponding to the duration of the DTX cycle and at a frequency corresponding to the periodicity of the DTX cycle.

Each DTX and/or DRX cycle may be configured by the network entity 210 by transmitting RRC signaling and/or broadcast signaling (e.g., SSB) to the UE 205 that identifies various parameters for the DTX or DRX cycle. Such parameters may include, but are not limited to, the periodicity of the active or inactive periods within the cycle, the duration of each cycle, and the like. RRC signaling may then be used to activate or deactivate a cycle for the network entity 210.

However, such power saving techniques may create misalignment issues with respect to other communication techniques. For example, the UE 205 may be configured with SPS configurations that identify SPS resources (e.g., time, spatial, frequency, and/or code resources) available for downlink transmissions to the UE 205. For example, the SPS configurations identify a set of SPS occasions (e.g., the SPS occasions 240) where the SPS resources are defined or otherwise allocated as available for downlink transmissions to the UE 205 (e.g., PDCCH/PDSCH transmissions). The set of SPS occasions includes both downlink resources (e.g., SPS occasions 240) and uplink resources (e.g., uplink (UL) occasion 245) available for PUCCH/PUSCH transmissions. The UE 205 generally monitors the SPS occasions 240 to detect and receive such downlink transmissions from the network entity 210.

Wireless communications system 200 illustrates a non-limiting example of misalignment issues where a first subset of SPS occasions overlap in the time domain with the active period 225 of the DTX cycle (with two SPS occasions 240 overlapping with the active period 225 in this non-limiting example) of the network entity 210. A second subset of SPS occasions overlap in the time domain with the inactive period 230 of the DTX cycle (with six SPS occasions 240 overlapping with the inactive period 230 in this non-limiting example) of the network entity 210. This misalignment creates an issue where the UE 205 is scheduled with some SPS occasions 240 (e.g., those in the first subset of the set) where the UE 205 may receive downlink transmissions from the network entity 210 and other SPS occasions 240 (e.g., those in the second subset of the set) where the UE 205 will not receive downlink transmissions from the network entity 210 because of the inactive period 230 of the DTX cycle.

Aspects of the SPS configurations identify or otherwise allocated uplink resources for the UE 205 to transmit or otherwise provide a feedback transmission 250 associated with the downlink transmissions occurring during the SPS occasions 240. For example, the SPS configurations may identify PUCCH and/or PUSCH resources available for transmitting HARQ-ACK feedback (e.g., the feedback transmission 250) for the downlink transmissions. In some wireless networks, the feedback transmission 250 is scheduled to be transmitted a (pre) configured or otherwise identified time period 255 between the last SPS occasion 240 in the set and the feedback transmission 250. Accordingly, at the end of all SPS repetitions in the set, the UE 205 is expected to transmit the HARQ-ACK in a PUCCH occasion after a time offset from the last SPS repetition. However, due to the interaction of the SPS occasions 240 with the DTX operations of the cell (e.g., the network entity 210), not all of the SPS occasions 240 can be used for transmitting the downlink transmissions to the UE 205. Accordingly, the UE 205 is now expected to monitor each SPS occasion 240 in the set (even when those occasions overlap with the inactive period 230) as well as store the feedback transmission 250 (e.g., store the HARQ-ACK feedback information in a HARQ buffer) until the scheduled PUCCH occasion.

Accordingly, aspects of the techniques described herein provide various mechanisms to address such misalignment issues within a wireless network. Aspects of the described techniques relate to whether or not the UE 205 is to perform or drop the feedback transmission 250 when there is an overlap with SPS occasions 240 with the inactive period 230 of the DTX cycle of the network entity 210. Aspects of the described techniques relate to when the feedback transmission 250 is to be performed when there is an overlap. Further aspects relate to DTX cycle activation and deactivation using lower layer (e.g., layer one) signaling, such as DCI signaling.

The UE 205 may monitor one, some, or all of the SPS occasions 240 in the set of SPS occasions (pre) configured for the UE 205 at 215. The set of SPS occasions may be (pre) configured for the UE 205 using RRC signaling, MAC-CE signaling, or some other higher layer signaling (e.g., IP-based signaling). The UE 205 may monitor the SPS occasions 240 in order to detect and receive a downlink transmission from the network entity 210. As discussed above and shown in FIG. 2, a first subset (two, in this example) of the SPS occasions 240 may overlap with the active period 225 while a second subset (six, in this example) of the SPS occasions 240 may overlap with the inactive period 230. The UE 205 may not expect to receive downlink transmissions from the network entity 210 during the SPS occasions 240 in the second subset due to the DTX cycle of the network entity 210.

Due to the overlap between the second subset of SPS occasions 240 and the inactive period 230, the UE 205 may selectively perform or drop the feedback transmission 250 at 220. That is, the UE 205 may select or otherwise determine to perform the feedback transmission 250 or may select or otherwise determine to drop (e.g., not perform or otherwise transmit) the feedback transmission 250. Dropping the feedback transmission 250 may reduce complexity and improve performance at the UE 205 by clearing the HARQ buffer as well as associated timer(s) or other tracking function(s).

In one example, the UE 205 may select or otherwise determine to drop the feedback transmission 250 because of the overlap between the SPS occasions 240 in the second subset and the inactive period 230 of the DTX cycle of the network entity 210. That is, the UE 205 drops the HARQ-ACK transmission because of the overlap.

In another example, the UE 205 may select or otherwise determine to drop the feedback transmission 250 based on how many SPS occasions 240 are in the first subset (overlapping with the active period 225) and/or in the second subset (overlapping with the inactive period 230). For example, a threshold may be (pre) configured, signaled (e.g., via RRC signaling), or otherwise identified that defines the number of (e.g., the numerical quantity of) SPS occasions 240 within the first subset of SPS occasions 240 and/or the second subset of SPS occasions 240. The UE 205 may select or otherwise determine to drop the feedback transmission 250 based on the number of SPS occasions 240 in the first subset failing to satisfy the threshold. That is, the UE 205 may drop the HARQ-ACK transmission if the SPS repetitions (e.g., SPS occasions 240) within the active time of the DTX cycle are smaller than a given threshold. Conversely, the UE 205 may select or otherwise determine to perform the feedback transmission 250 if the number of SPS occasions 240 within the active period 225 satisfy the threshold. The threshold may also be related to the number of SPS occasions 240 in the second subset (e.g., based on how many of the SPS occasions 240 that lie within the inactive period 230).

In another example, the UE 205 may disregard the overlap between the SPS occasions 240 in the second subset and the inactive period 230 and perform the feedback transmission 250.

Accordingly, the UE 205 may improve HARQ-ACK feedback when the alignment between one, some, or all of the SPS occasions 240 of the UE 205 and the inactive period 230 of the network entity 210. Based on the overlap, the network entity 210 may also selectively receive or drop the feedback transmission 250 according to the techniques discussed herein. Although the examples discussed herein relate to DTX operations, such techniques may also be applied during DRX cycles of the network entity 210 where one, some, or all of the configured grant (CG) occasions (e.g., semi-persistently scheduled uplink resources) overlap with inactive periods of the DRX cycle. For example, the UE 205 may selectively receive or drop the HARQ-ACK feedback from the network entity 210 due to the overlap.

Additionally, or alternatively, aspects of the techniques described herein further address DTX cycle activation and/or deactivation at the UE 205. The network entity 210 may transmit or otherwise provide (and the UE 205 may receive or otherwise obtain) RRC signaling or other mechanisms that (pre) configure parameters for the DTX and/or DRX cycle of the network entity 210. The network entity 210 may further transmit or otherwise provide (and the UE 205 may receive or otherwise obtain) additional signaling that activates or deactivates a DTX and/or DRX cycle. In some examples, the UE 205 may receive RRC signaling that activates or deactivates the DTX and/or DRX cycle of the network entity 210.

The UE 205 may also be operating in a DTX and/or DRX cycle that includes active and inactive periods. One example may include a connected mode-DRX (C-DRX) where the UE 205 receives downlink transmissions during active periods of the C-DRX and inactive periods where the UE 205 does not monitor for downlink transmissions.

In some examples, additional signaling techniques may be applied (in addition to or alternatively to) to support activation or deactivation of the DTX and/or DRX cycle for the network entity 210. A DCI message may be used to activate or deactivate the DTX or DRX cycle. The UE 205 may selectively monitor for the DCI message indicating that or otherwise associated with activating or deactivating the DTX and/or DRX cycle of the network entity 210. The selective monitoring may be based on the active period of the C-DTX (or C-DRX) cycle of the UE 205. The UE 205 may monitor for the DCI message in the active period, in the inactive period, or during both periods, of its C-DRX cycle.

The DCI message may be either a UE-specific DCI message or a group common DCI message. In some examples, the type of DCI message used to activate or deactivate the DTX and/or DRX cycle of the network entity 210 may be based on the C-DRX cycle of the UE 205. For example, the UE 205 may monitor for the UE-specific DCI message during the active period of the DTX cycle (e.g., during the active period of the C-DRX cycle of the UE 205 that may align or may not align with an active period of the DTX cycle of the network entity 210). The UE 205 may monitor for the UE-specific DCI for cell DTX/DRX activation/deactivation if the UE 205 is in the active time period of the UE C-DRX cycle.

In another example, the UE 205 may monitor for the group-common DCI message during the inactive period of the DTX cycle (e.g., during the inactive period of the C-DRX cycle of the UE 205 that may align or may not align with the inactive period of the DTX cycle of the network entity 210). The UE may monitor for the UE group common DCI message for cell DTX/DRX activation/deactivation if the UE 205 is outside of the active time period of the UE C-DRX cycle.

In some examples, the UE 205 may not monitor (e.g., refrain from monitoring) for the DCI message when the PDCCH monitoring occasion fall into the non-active time period of cell DTX. That is, the UE 205 may refrain from monitoring for the DCI message during monitoring occasions occurring outside of the active period and during the inactive period of the DTX cycle of the network entity 210. The UE 205 may receive a signal (e.g., RRC signal, MAC-CE, or other DCI message) that indicates or otherwise informs the UE 205 of whether it is to monitor for the DCI message activating or deactivating the DTX or DRX cycle of the network entity 210 during inactive period 230 of the DTX cycle of the network entity 210.

In some examples, the UE 205 may transmit or otherwise provide UE capability signaling indicating whether or not the UE 205 supports layer one (e.g., DCI message) signaling for cell DTX/DRX activation/deactivation. For example, the UE 205 may transmit or otherwise provide (and the network entity 210 may receive or otherwise obtain) a UE capability message that carries or otherwise conveys an indication of support for activating or deactivating the DTX cycle via the DCI message. The cell DTX and/or DRX may be activated or deactivated by RRC signaling. This activation or deactivation may be based, at least in some aspects, on the channel restriction during inactive time periods of the cell DTX/DRX cycle. The channel restriction may include the UE 205 refraining from monitoring for the DCI message outside of the active period and during the inactive period of the DTX cycle of the network entity 210.

Accordingly, the UE 205 and the network entity 210 may communicate according to the DTX and/or DRX cycle(s) of the UE 205 and/or the network entity 210.

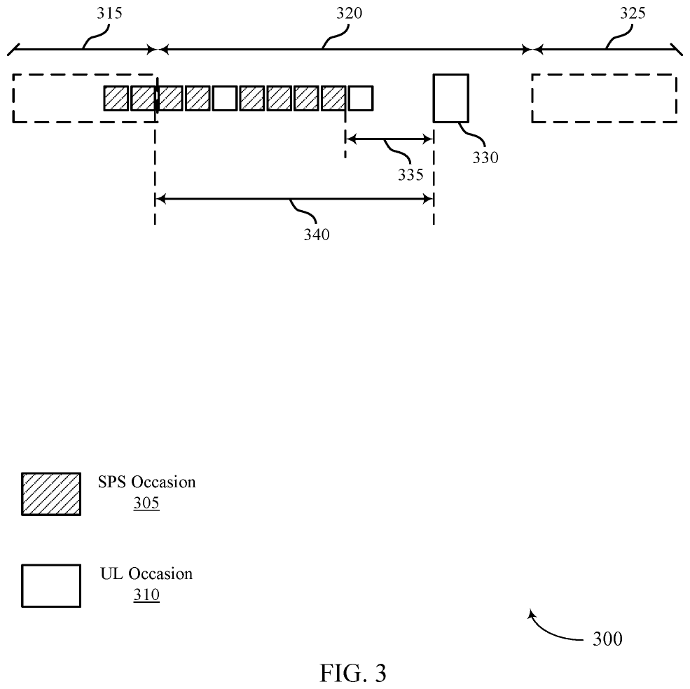

FIG. 3 shows an example of an overlap configuration 300 that supports feedback during cell DTX operation in accordance with one or more aspects of the present disclosure. Overlap configuration 300 may implement aspects of wireless communications system 100 and/or wireless communications system 200. Aspects of overlap configuration 300 may be implemented at or implemented by a UE and/or a network entity, which may be examples of the corresponding devices described herein.

A UE may monitor a set of SPS occasions (e.g., SPS occasions 305) associated with downlink transmissions from a network entity. The SPS occasions 305 may be time resources of the SPS configuration where the UE monitors the frequency, spatial, or other resources of the SPS configuration. The SPS configuration may further identify or otherwise define one or more uplink occasions 310 as part of the semi-persistent resources (pre) configured for the UE. A first subset of SPS occasions in the set of SPS occasions may overlap in the time domain with an active period 315 of a DTX cycle of the network entity. A second subset of SPS occasions in the set of SPS occasions may overlap in the time domain with an inactive period 320 of the DTX cycle of the network entity. The DTX cycle may include a second active period 325. In the non-limiting example shown in FIG. 3, the set of SPS occasions include eight SPS occasions 305 and two uplink occasions 310. In this example, the first subset of SPS occasions include the first two SPS occasions 305 in the set and the second subset of SPS occasions included the last six SPS occasions 305 in the set as well as the two uplink occasions 310.

The UE may selectively perform (e.g., transmit) or drop (e.g., not transmit) the feedback transmission 330 (e.g., HARQ-ACK feedback) associated with the monitoring of the SPS occasions 305 based on the overlap. The selection may be based on the overlap between the first subset of SPS occasions and the active period 315 and/or based on the overlap between the second subset of SPS occasions and the inactive period 320.

In some aspects, the UE may perform the feedback transmission 330 based on the overlap between the first subset of SPS occasions in the set and the active period 315. The UE may perform the feedback transmission 330 after a last SPS occasion in the set. Overlap configuration 300 illustrates two non-limiting examples of how the last SPS occasion in the set is defined or otherwise identified.

In one example, the last SPS occasion may be defined or otherwise identified as the sequentially last SPS occasion 305 in the set of SPS occasions. That is, the UE may transmit the HARQ-ACK in the PUCCH resource determined based on no cell DTX operations (e.g., based on a time offset 335 from the last SPS occasion 305 whether that SPS occasion 305 was used for downlink transmissions or not).

In another example, the last SPS occasion may be defined or otherwise identified as the last (e.g., sequentially last) SPS occasion 305 in the first subset of SPS occasions. That is, the last SPS occasion 305 may be defined or otherwise identified as the last SPS occasion 305 that is within the active period 315 of the DTX cycle of the network entity. The UE may transmit the HARQ-ACK in the PUCCH occasion after the time period 340 that is with reference to the SPS occasions within the active period 315. The UE may perform the feedback transmission 330 earlier than when the last SPS occasion is defined as the sequentially last SPS occasion in the set. Transmitting the HARQ-ACK feedback with reference to the last transmitted SPS occasion 305 may clear up the buffer of the UE as well as indicate to the network an early downlink transmission success, which will save energy at both the UE and the network.

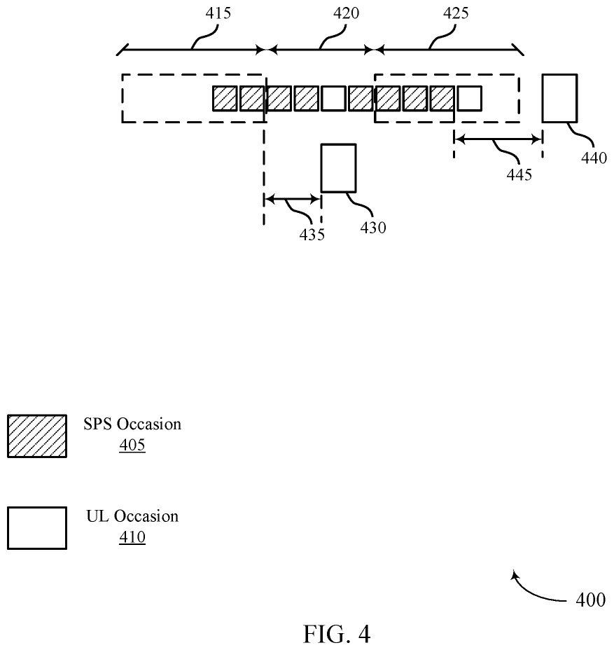

FIG. 4 shows an example of an overlap configuration 400 that supports feedback during cell DTX operation in accordance with one or more aspects of the present disclosure. Overlap configuration 400 may implement aspects of wireless communications system 100 and/or wireless communications system 200 and/or aspects of overlap configuration 300. Aspects of overlap configuration 400 may be implemented at or implemented by a UE and/or a network entity, which may be examples of the corresponding devices described herein.

A UE may monitor a set of SPS occasions (e.g., SPS occasions 405) associated with downlink transmissions from a network entity. The SPS occasions 405 may be time resources of the SPS configuration where the UE monitors the frequency, spatial, or other resources of the SPS configuration. The SPS configuration may further identify or otherwise define one or more uplink occasions 410 as part of the semi-persistent resources (pre) configured for the UE. A first subset of SPS occasions in the set of SPS occasions may overlap in the time domain with an active period 415 of a DTX cycle of the network entity. A second subset of SPS occasions in the set of SPS occasions may overlap in the time domain with an inactive period 420 of the DTX cycle of the network entity. A third subset of SPS occasions in the set of SPS occasions may overlap in the time domain with a second active period 425 of the DTX cycle. In the non-limiting example shown in FIG. 4, the set of SPS occasions include eight SPS occasions 405 and two uplink occasions 410. In this example, the first subset of SPS occasions include the first two SPS occasions 405 in the set, the second subset of SPS occasions includes three SPS occasions 405 in the set as well as the one uplink occasion 410, and the third subset of SPS occasions includes three SPS occasions in the set as well as one uplink occasion 410.

Overlap configuration 400 illustrates a non-limiting example of a low periodicity DTX cycle configuration where some SPS repetitions fall within the first active period and other SPS occasions fall within the second active period.

The UE may selectively perform (e.g., transmit) or drop (e.g., not transmit) the feedback message (e.g., HARQ-ACK feedback) associated with the monitoring of the SPS occasions 405 based on the overlap. The selection may be based on the overlap between the first subset of SPS occasions and the active period 415, based on the overlap between the second subset of SPS occasions and the inactive period 420, and/or based on the overlap between the third subset of SPS occasions and the second active period.

In one example, the UE may perform the feedback transmission 440 based on the overlap between the first subset of SPS occasions in the set and the active period 415. For example, the UE may perform the feedback transmission 440 after a time delay 445 relative to the sequentially last SPS occasion 405 in the set.

In another example, the UE may perform the feedback transmission 430 after a time delay 435 relative to the last SPS occasion in the first subset of SPS occasions that overlap with the active period 415. When some SPS occasions 405 fall within an active duration and others fall within the following activation duration of the DTX cycle of the network entity, the UE may send an early HARQ-ACK indication (e.g., the feedback transmission 430) after the first active period and before the second active period (e.g., during the inactive period 420). The UE may perform the feedback transmission 430 using the uplink occasion 410 occurring during the inactive period of the DTX cycle of the network entity.

Aspects of this example may be based on various conditions. For example, the determination to perform the feedback transmission 430 during the uplink occasion 410 in the inactive period 420 may be based on the number of SPS occasions in the active period 415 and/or the time offset of the PUCCH occasion (e.g., uplink occasion 410) from the start of the second active period 425. Performing the HARQ-ACK transmission earlier (e.g., during the uplink occasion 410 in the inactive period 420) may enable lower latency HARQ-ACK feedback transmissions.

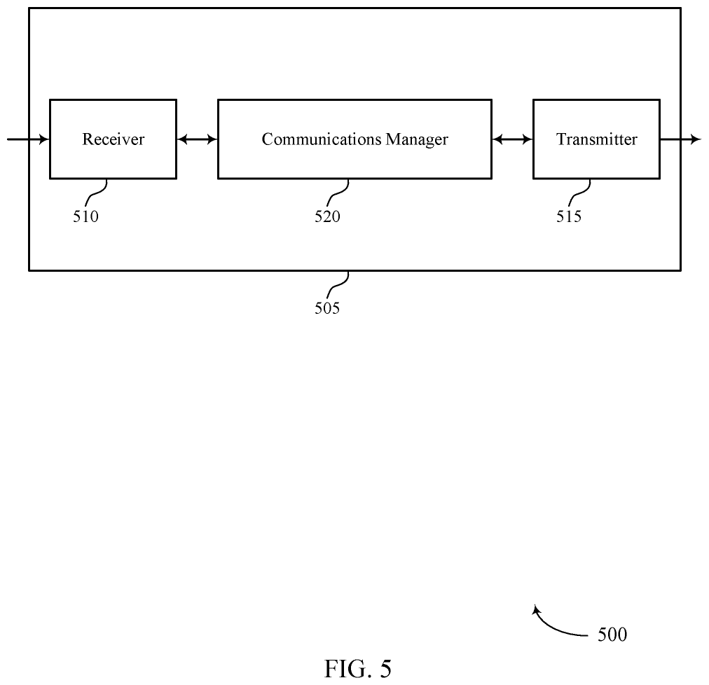

FIG. 5 shows a block diagram 500 of a device 505 that supports feedback during cell DTX operation in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to feedback during cell DTX operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to feedback during cell DTX operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of feedback during cell DTX operation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle. The communications manager 520 is capable of, configured to, or operable to support a means for selectively performing or dropping a feedback transmission associated with the monitoring based on the overlap between the second subset of SPS occasions and the inactive period of the DTX cycle.

Additionally, or alternatively, the communications manager 520 may support wireless communications at a UE in accordance with examples as disclosed herein. For example, the communications manager 520 is capable of, configured to, or operable to support a means for selectively monitoring, based on an active period of a DTX cycle of a network entity, for a downlink control information message associated with activating or deactivating the DTX cycle of a network entity, the downlink control information message including a UE-specific downlink control information message, a group common downlink control information message, or both. The communications manager 520 is capable of, configured to, or operable to support a means for communicating with the network entity according to the DTX cycle based on the selective monitoring.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for improved HARQ-ACK feedback during cell DTX/DRX operations and SPS occasion overlap.

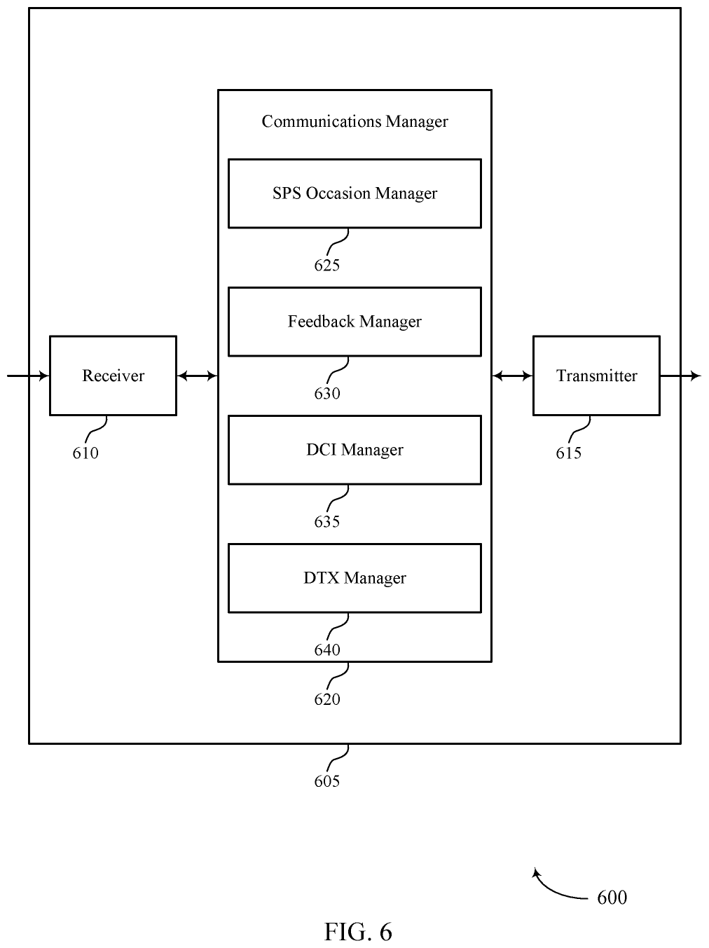

FIG. 6 shows a block diagram 600 of a device 605 that supports feedback during cell DTX operation in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to feedback during cell DTX operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to feedback during cell DTX operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of feedback during cell DTX operation as described herein. For example, the communications manager 620 may include an SPS occasion manager 625, a feedback manager 630, a DCI manager 635, a DTX manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The SPS occasion manager 625 is capable of, configured to, or operable to support a means for monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle. The feedback manager 630 is capable of, configured to, or operable to support a means for selectively performing or dropping a feedback transmission associated with the monitoring based on the overlap between the second subset of SPS occasions and the inactive period of the DTX cycle.

Additionally, or alternatively, the communications manager 620 may support wireless communications at a UE in accordance with examples as disclosed herein. The DCI manager 635 is capable of, configured to, or operable to support a means for selectively monitoring, based on an active period of a DTX cycle of a network entity, for a downlink control information message associated with activating or deactivating the DTX cycle of a network entity, the downlink control information message including a UE-specific downlink control information message, a group common downlink control information message, or both. The DTX manager 640 is capable of, configured to, or operable to support a means for communicating with the network entity according to the DTX cycle based on the selective monitoring.

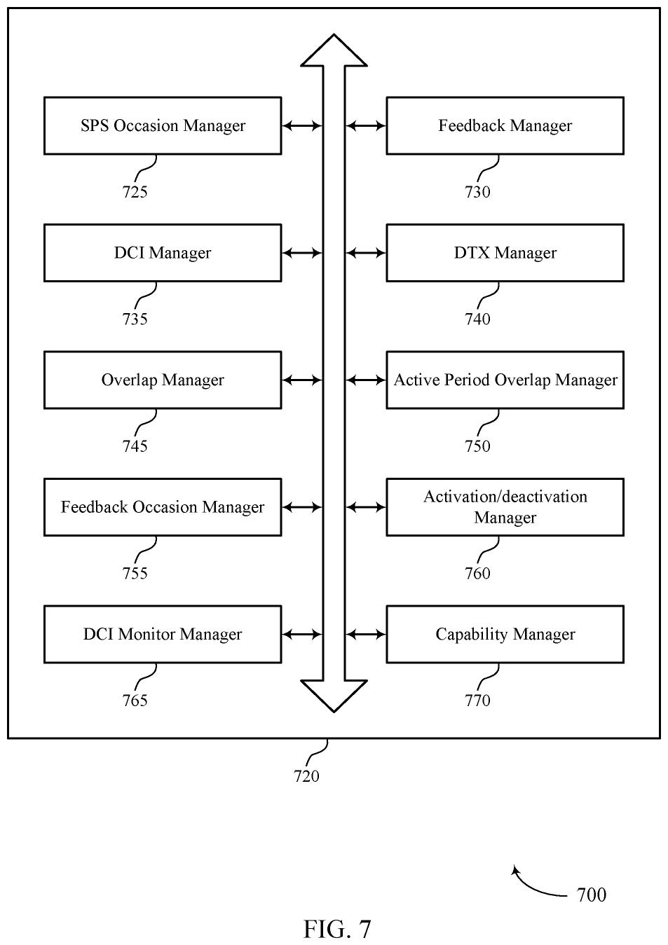

FIG. 7 shows a block diagram 700 of a communications manager 720 that supports feedback during cell DTX operation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of feedback during cell DTX operation as described herein. For example, the communications manager 720 may include an SPS occasion manager 725, a feedback manager 730, a DCI manager 735, a DTX manager 740, an overlap manager 745, an active period overlap manager 750, a feedback occasion manager 755, an activation/deactivation manager 760, a DCI monitor manager 765, a capability manager 770, or any combination thereof. Each of these components may communicate, directly or indirectly, with one another (e.g., via one or more buses).

The communications manager 720 may support wireless communications at a UE in accordance with examples as disclosed herein. The SPS occasion manager 725 is capable of, configured to, or operable to support a means for monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle. The feedback manager 730 is capable of, configured to, or operable to support a means for selectively performing or dropping a feedback transmission associated with the monitoring based on the overlap between the second subset of SPS occasions and the inactive period of the DTX cycle.

In some examples, to support selectively performing or dropping the feedback transmission, the overlap manager 745 is capable of, configured to, or operable to support a means for dropping the feedback transmission based on the overlap between the second subset of SPS occasions and the inactive period.

In some examples, to support selectively performing or dropping the feedback transmission, the overlap manager 745 is capable of, configured to, or operable to support a means for dropping the feedback transmission based on a numerical quantity of SPS occasions in the first subset of SPS occasions overlapping with the active period of the DTX cycle failing to satisfy a threshold.

In some examples, to support selectively performing or dropping the feedback transmission, the active period overlap manager 750 is capable of, configured to, or operable to support a means for performing the feedback transmission based on the overlap between the first subset of SPS occasions and the active period of the DTX cycle, the feedback transmission performed after a last SPS occasion. In some examples, the last SPS occasion includes a sequentially last scheduled SPS occasion in the set of SPS occasions. In some examples, the last SPS occasion includes a last SPS occasion of the first subset of SPS occasions overlapping with the active period of the DTX cycle.

In some examples, to support selectively performing or dropping the feedback transmission, the feedback occasion manager 755 is capable of, configured to, or operable to support a means for performing the feedback transmission during an uplink occasion occurring during the second subset of SPS occasions based on a third subset of SPS occasions in the set of SPS occasions scheduled during a second active period of the DTX cycle, the second active period following the inactive period of the DTX cycle in the time domain. In some examples, performing the feedback transmission is based on a numerical quantity of SPS occasions in the first subset of SPS occasions, a time offset between the uplink occasion and a start of the second active period, or both.

Additionally, or alternatively, the communications manager 720 may support wireless communications at a UE in accordance with examples as disclosed herein. The DCI manager 735 is capable of, configured to, or operable to support a means for selectively monitoring, based on an active period of a DTX cycle of a network entity, for a downlink control information message associated with activating or deactivating the DTX cycle of a network entity, the downlink control information message including a UE-specific downlink control information message, a group common downlink control information message, or both. The DTX manager 740 is capable of, configured to, or operable to support a means for communicating with the network entity according to the DTX cycle based on the selective monitoring.

In some examples, to support selective monitoring, the activation/deactivation manager 760 is capable of, configured to, or operable to support a means for monitoring for the UE-specific downlink control information message during the active period of the DTX cycle. In some examples, to support selective monitoring, the activation/deactivation manager 760 is capable of, configured to, or operable to support a means for monitoring for the group common downlink control information message outside of the active period and during an inactive period of the DTX cycle.

In some examples, to support selective monitoring, the DCI monitor manager 765 is capable of, configured to, or operable to support a means for refraining from monitoring for the downlink control information message during one or more monitoring occasions occurring outside of the active period and during an inactive period of the DTX cycle. In some examples, the DCI monitor manager 765 is capable of, configured to, or operable to support a means for receiving a signal indicating that the UE is to refrain from monitoring for the downlink control information message during one or more monitoring occasions occurring outside of the active period and during an inactive period of the DTX cycle.

In some examples, the capability manager 770 is capable of, configured to, or operable to support a means for transmitting a UE capability message indicating support for activating or deactivating the DTX cycle via the downlink control information message. In some examples, the support includes support for refraining from monitoring for the downlink control information message outside of the active period and during an inactive period of the DTX cycle.

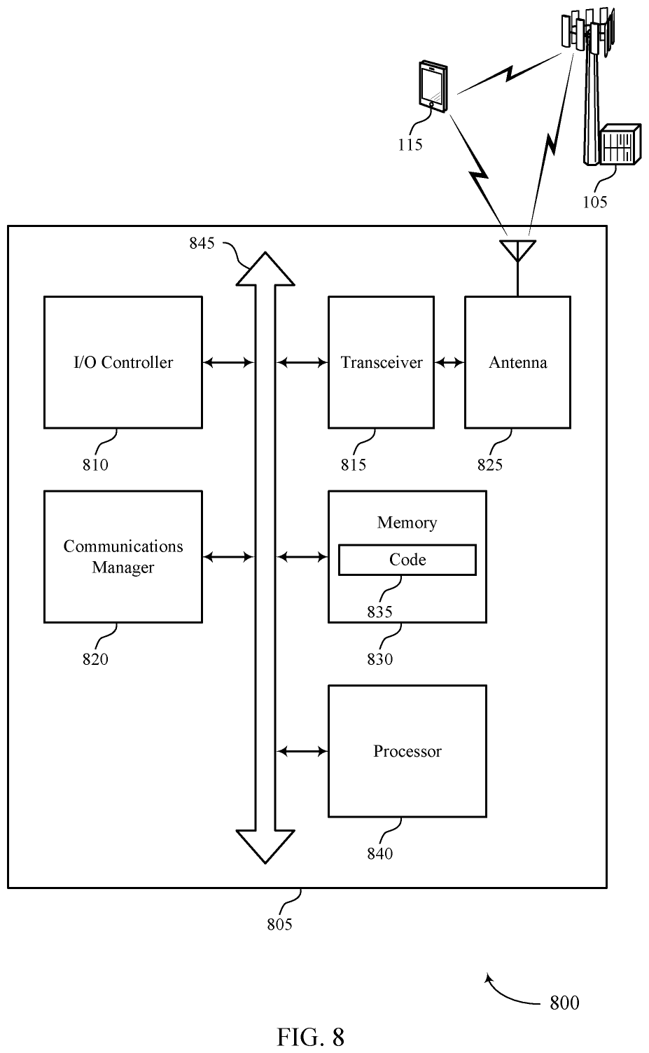

FIG. 8 shows a diagram of a system 800 including a device 805 that supports feedback during cell DTX operation in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting feedback during cell DTX operation). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle. The communications manager 820 is capable of, configured to, or operable to support a means for selectively performing or dropping a feedback transmission associated with the monitoring based on the overlap between the second subset of SPS occasions and the inactive period of the DTX cycle.

Additionally, or alternatively, the communications manager 820 may support wireless communications at a UE in accordance with examples as disclosed herein. For example, the communications manager 820 is capable of, configured to, or operable to support a means for selectively monitoring, based on an active period of a DTX cycle of a network entity, for a downlink control information message associated with activating or deactivating the DTX cycle of a network entity, the downlink control information message including a UE-specific downlink control information message, a group common downlink control information message, or both. The communications manager 820 is capable of, configured to, or operable to support a means for communicating with the network entity according to the DTX cycle based on the selective monitoring.

By including or configuring the communications manager 820 in accordance with examples as described herein, the device 805 may support techniques for improved HARQ-ACK feedback during cell DTX/DRX operations and SPS occasion overlap.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of feedback during cell DTX operation as described herein, or the processor 840 and the memory 830 may be otherwise configured to perform or support such operations.

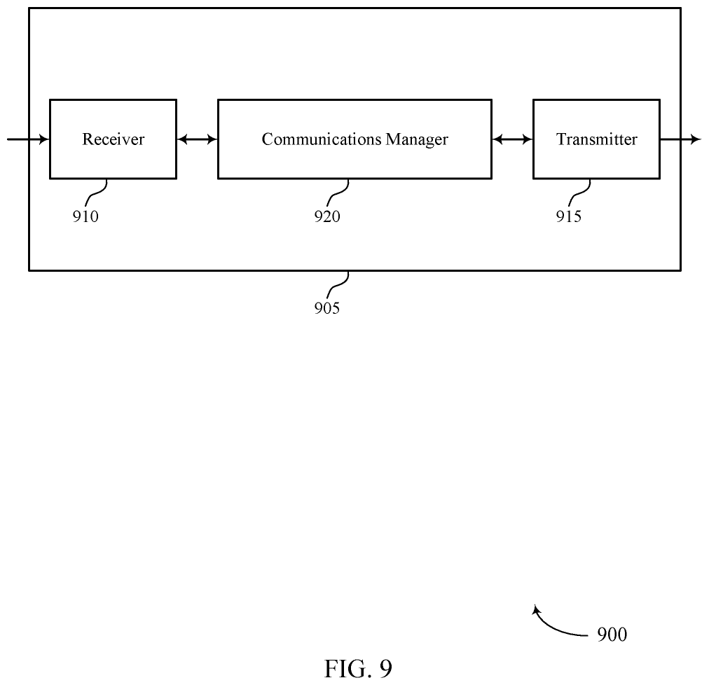

FIG. 9 shows a block diagram 900 of a device 905 that supports feedback during cell DTX operation in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of feedback during cell DTX operation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle. The communications manager 920 is capable of, configured to, or operable to support a means for selectively receiving or dropping a feedback transmission from the UE associated with the one or more downlink transmissions based on the overlap between the second subset of SPS occasions and the inactive period of the DTX cycle.

Additionally, or alternatively, the communications manager 920 may support wireless communications at a network entity in accordance with examples as disclosed herein. For example, the communications manager 920 is capable of, configured to, or operable to support a means for selectively transmitting, to a UE and based on an active period of a DTX cycle of the network entity, a downlink control information message associated with activating or deactivating the DTX cycle, the downlink control information message including a UE-specific downlink control information message, a group common downlink control information message, or both. The communications manager 920 is capable of, configured to, or operable to support a means for communicating with the UE according to the DTX cycle based on the selective transmitting.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for improved HARQ-ACK feedback during cell DTX/DRX operations and SPS occasion overlap.

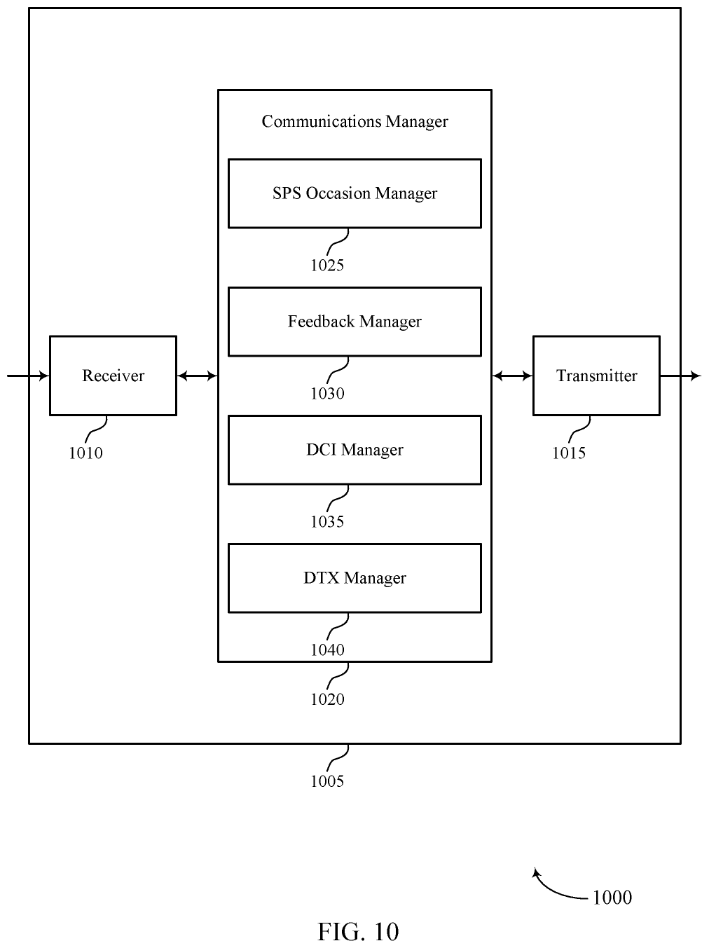

FIG. 10 shows a block diagram 1000 of a device 1005 that supports feedback during cell DTX operation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of feedback during cell DTX operation as described herein. For example, the communications manager 1020 may include an SPS occasion manager 1025, a feedback manager 1030, a DCI manager 1035, a DTX manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The SPS occasion manager 1025 is capable of, configured to, or operable to support a means for performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle. The feedback manager 1030 is capable of, configured to, or operable to support a means for selectively receiving or dropping a feedback transmission from the UE associated with the one or more downlink transmissions based on the overlap between the second subset of SPS occasions and the inactive period of the DTX cycle.

Additionally, or alternatively, the communications manager 1020 may support wireless communications at a network entity in accordance with examples as disclosed herein. The DCI manager 1035 is capable of, configured to, or operable to support a means for selectively transmitting, to a UE and based on an active period of a DTX cycle of the network entity, a downlink control information message associated with activating or deactivating the DTX cycle, the downlink control information message including a UE-specific downlink control information message, a group common downlink control information message, or both. The DTX manager 1040 is capable of, configured to, or operable to support a means for communicating with the UE according to the DTX cycle based on the selective transmitting.

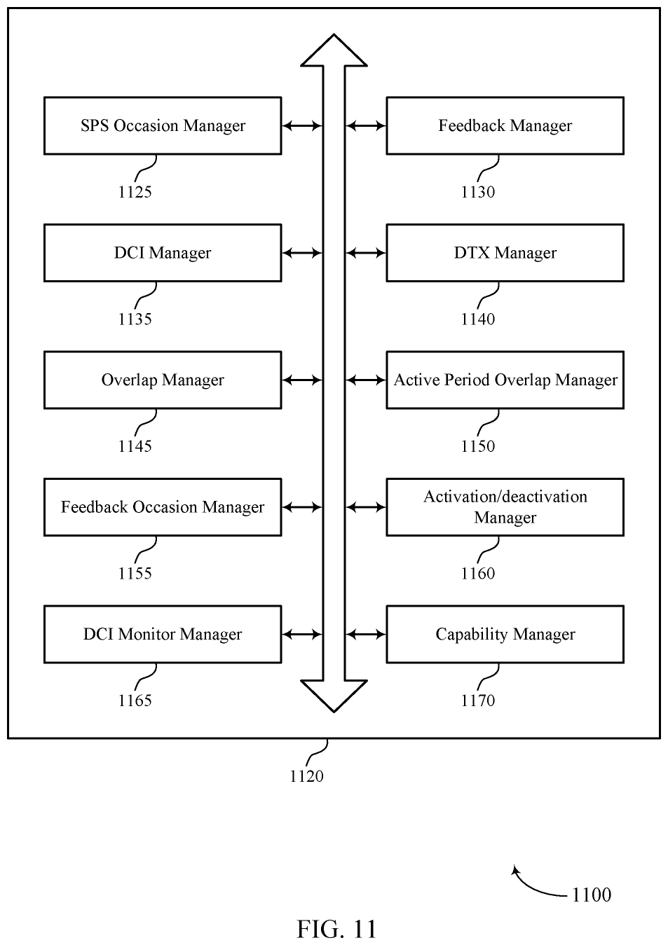

FIG. 11 shows a block diagram 1100 of a communications manager 1120 that supports feedback during cell DTX operation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of feedback during cell DTX operation as described herein. For example, the communications manager 1120 may include an SPS occasion manager 1125, a feedback manager 1130, a DCI manager 1135, a DTX manager 1140, an overlap manager 1145, an active period overlap manager 1150, a feedback occasion manager 1155, an activation/deactivation manager 1160, a DCI monitor manager 1165, a capability manager 1170, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The SPS occasion manager 1125 is capable of, configured to, or operable to support a means for performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle. The feedback manager 1130 is capable of, configured to, or operable to support a means for selectively receiving or dropping a feedback transmission from the UE associated with the one or more downlink transmissions based on the overlap between the second subset of SPS occasions and the inactive period of the DTX cycle.

In some examples, to support selectively receiving or dropping the feedback transmission, the overlap manager 1145 is capable of, configured to, or operable to support a means for dropping the feedback transmission based on the overlap between the second subset of SPS occasions and the inactive period. In some examples, to support selectively receiving or dropping the feedback transmission, the overlap manager 1145 is capable of, configured to, or operable to support a means for dropping the feedback transmission based on a numerical quantity of SPS occasions in the first subset of SPS occasions overlapping with the active period of the DTX cycle failing to satisfy a threshold.

In some examples, to support selectively receiving or dropping the feedback transmission, the active period overlap manager 1150 is capable of, configured to, or operable to support a means for receiving the feedback transmission based on the overlap between the first subset of SPS occasions and the active period of the DTX cycle, the feedback transmission performed after a last SPS occasion. In some examples, the last SPS occasion includes a sequentially last scheduled SPS occasion in the set of SPS occasions. In some examples, the last SPS occasion includes a last SPS occasion of the first subset of SPS occasions overlapping with the active period of the DTX cycle.

In some examples, to support selectively receiving or dropping the feedback transmission, the feedback occasion manager 1155 is capable of, configured to, or operable to support a means for receiving the feedback transmission during an uplink occasion occurring during the second subset of SPS occasions based on a third subset of SPS occasions in the set of SPS occasions scheduled during a second active period of the DTX cycle, the second active period following the inactive period of the DTX cycle in the time domain. In some examples, receiving the feedback transmission is based on a numerical quantity of SPS occasions in the first subset of SPS occasions, a time offset between the uplink occasion and a start of the second active period, or both.

Additionally, or alternatively, the communications manager 1120 may support wireless communications at a network entity in accordance with examples as disclosed herein. The DCI manager 1135 is capable of, configured to, or operable to support a means for selectively transmitting, to a UE and based on an active period of a DTX cycle of the network entity, a downlink control information message associated with activating or deactivating the DTX cycle, the downlink control information message including a UE-specific downlink control information message, a group common downlink control information message, or both. The DTX manager 1140 is capable of, configured to, or operable to support a means for communicating with the UE according to the DTX cycle based on the selective transmitting.

In some examples, to support selective transmitting, the activation/deactivation manager 1160 is capable of, configured to, or operable to support a means for transmitting the UE-specific downlink control information message during the active period of the DTX cycle. In some examples, to support selective transmitting, the activation/deactivation manager 1160 is capable of, configured to, or operable to support a means for transmitting the group common downlink control information message outside of the active period and during an inactive period of the DTX cycle.

In some examples, to support selective transmitting, the DCI monitor manager 1165 is capable of, configured to, or operable to support a means for refraining from transmitting the downlink control information message during one or more monitoring occasions occurring outside of the active period and during an inactive period of the DTX cycle. In some examples, the DCI monitor manager 1165 is capable of, configured to, or operable to support a means for transmitting a signal indicating that the UE is to refrain from monitoring for the downlink control information message during one or more monitoring occasions occurring outside of the active period and during an inactive period of the DTX cycle.

In some examples, the capability manager 1170 is capable of, configured to, or operable to support a means for receiving a UE capability message indicating support for activating or deactivating the DTX cycle via the downlink control information message. In some examples, the support includes support for refraining from monitoring for the downlink control information message outside of the active period and during an inactive period of the DTX cycle.

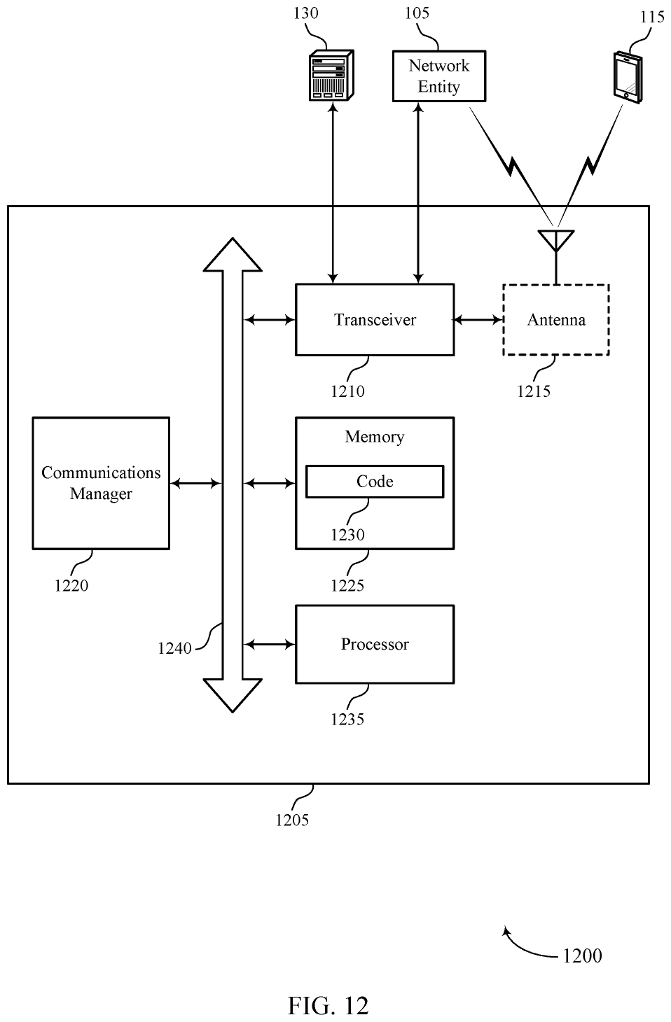

FIG. 12 shows a diagram of a system 1200 including a device 1205 that supports feedback during cell DTX operation in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting feedback during cell DTX operation). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle. The communications manager 1220 is capable of, configured to, or operable to support a means for selectively receiving or dropping a feedback transmission from the UE associated with the one or more downlink transmissions based on the overlap between the second subset of SPS occasions and the inactive period of the DTX cycle.

Additionally, or alternatively, the communications manager 1220 may support wireless communications at a network entity in accordance with examples as disclosed herein. For example, the communications manager 1220 is capable of, configured to, or operable to support a means for selectively transmitting, to a UE and based on an active period of a DTX cycle of the network entity, a downlink control information message associated with activating or deactivating the DTX cycle, the downlink control information message including a UE-specific downlink control information message, a group common downlink control information message, or both. The communications manager 1220 is capable of, configured to, or operable to support a means for communicating with the UE according to the DTX cycle based on the selective transmitting.

By including or configuring the communications manager 1220 in accordance with examples as described herein, the device 1205 may support techniques for improved HARQ-ACK feedback during cell DTX/DRX operations and SPS occasion overlap.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of feedback during cell DTX operation as described herein, or the processor 1235 and the memory 1225 may be otherwise configured to perform or support such operations.

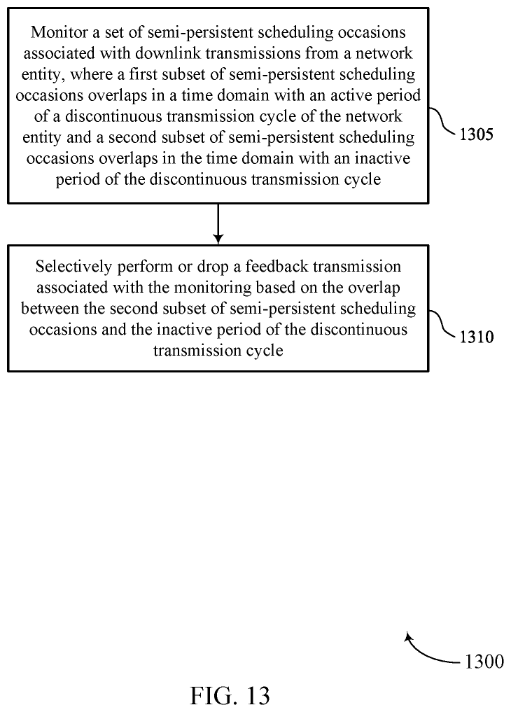

FIG. 13 shows a flowchart illustrating a method 1300 that supports feedback during cell DTX operation in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include monitoring a set of SPS occasions associated with downlink transmissions from a network entity, where a first subset of SPS occasions overlaps in a time domain with an active period of a DTX cycle of the network entity and a second subset of SPS occasions overlaps in the time domain with an inactive period of the DTX cycle. The operations of block 1305 may be performed in accordance with examples as disclosed herein. In some examples, aspects of the operations of 1305 may be performed by an SPS occasion manager 725 as described with reference to FIG. 7.

At 1310, the method may include selectively performing or dropping a feedback transmission associated with the monitoring based on the overlap between the second subset of SPS occasions and the inactive period of the DTX cycle. The operations of block 1310 may be performed in accordance with examples as disclosed herein. In some examples, aspects of the operations of 1310 may be performed by a feedback manager 730 as described with reference to FIG. 7.

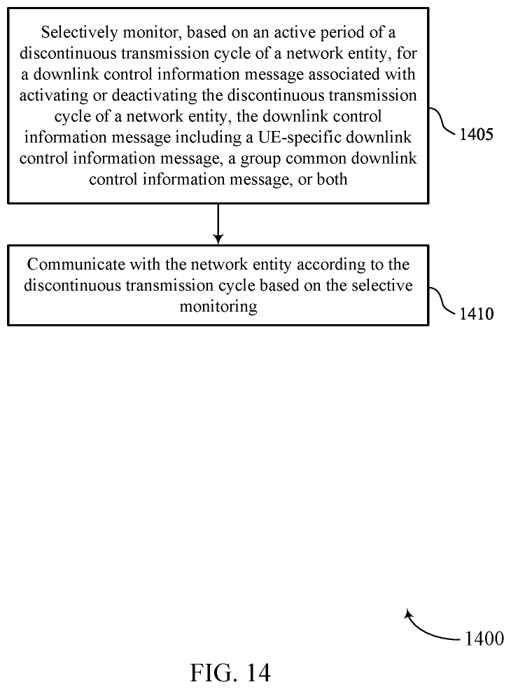

FIG. 14 shows a flowchart illustrating a method 1400 that supports feedback during cell DTX operation in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include selectively monitoring, based on an active period of a DTX cycle of a network entity, for a downlink control information message associated with activating or deactivating the DTX cycle of a network entity, the downlink control information message including a UE-specific downlink control information message, a group common downlink control information message, or both. The operations of block 1405 may be performed in accordance with examples as disclosed herein. In some examples, aspects of the operations of 1405 may be performed by a DCI manager 735 as described with reference to FIG. 7.

At 1410, the method may include communicating with the network entity according to the DTX cycle based on the selective monitoring. The operations of block 1410 may be performed in accordance with examples as disclosed herein. In some examples, aspects of the operations of 1410 may be performed by a DTX manager 740 as described with reference to FIG. 7.

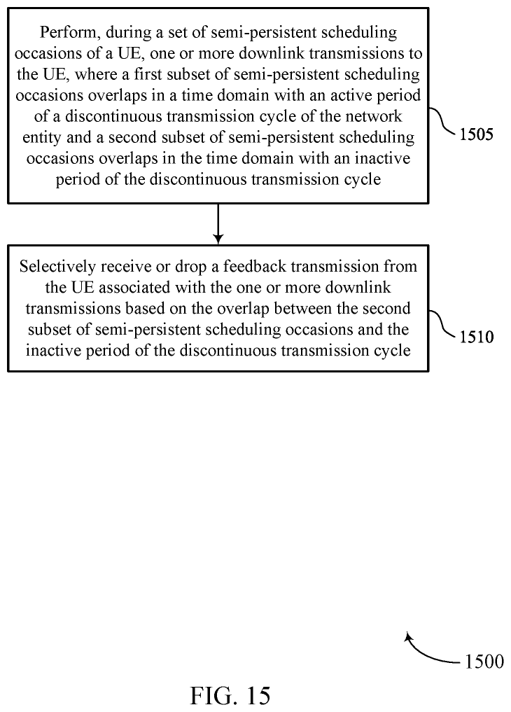

FIG. 15 shows a flowchart illustrating a method 1500 that supports feedback during cell DTX operation in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include performing, during a set of SPS occasions of a UE, one or more downlink transmissions to the UE, where a first subset of SPS occasions overlaps in a time domain with an active period of a DTX cycle of the network entity and a second subset of SPS occasions overlaps in the time domain with an inactive period of the DTX cycle. The operations of block 1505 may be performed in accordance with examples as disclosed herein. In some examples, aspects of the operations of 1505 may be performed by an SPS occasion manager 1125 as described with reference to FIG. 11.

At 1510, the method may include selectively receiving or dropping a feedback transmission from the UE associated with the one or more downlink transmissions based on the overlap between the second subset of SPS occasions and the inactive period of the DTX cycle. The operations of block 1510 may be performed in accordance with examples as disclosed herein. In some examples, aspects of the operations of 1510 may be performed by a feedback manager 1130 as described with reference to FIG. 11.

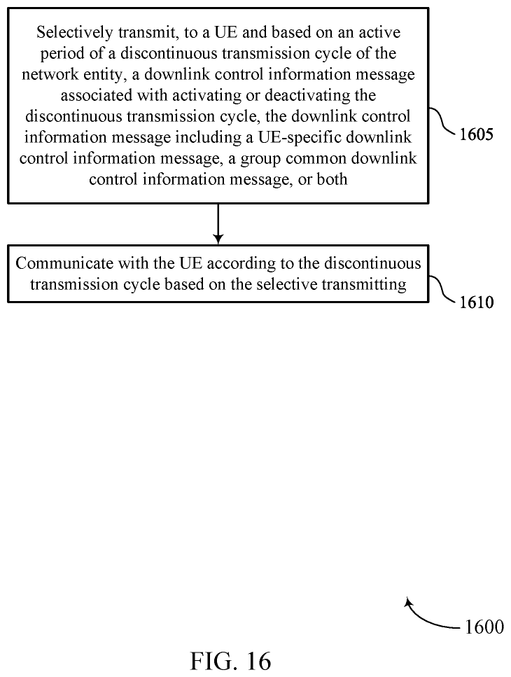

FIG. 16 shows a flowchart illustrating a method 1600 that supports feedback during cell DTX operation in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include selectively transmitting, to a UE and based on an active period of a DTX cycle of the network entity, a downlink control information message associated with activating or deactivating the DTX cycle, the downlink control information message including a UE-specific downlink control information message, a group common downlink control information message, or both. The operations of block 1605 may be performed in accordance with examples as disclosed herein. In some examples, aspects of the operations of 1605 may be performed by a DCI manager 1135 as described with reference to FIG. 11.

At 1610, the method may include communicating with the UE according to the DTX cycle based on the selective transmitting. The operations of block 1610 may be performed in accordance with examples as disclosed herein. In some examples, aspects of the operations of 1610 may be performed by a DTX manager 1140 as described with reference to FIG. 11.

The following provides an overview of aspects of the present disclosure:

Aspect 1: A method for wireless communications at a UE, comprising: monitoring a set of SPS occasions associated with downlink transmissions from a network entity, wherein a first subset of SPS occasions overlaps in a time domain with an active period of a DTX cycle of the network entity and a second subset of SPS occasions overlaps in the time domain with an inactive period of the DTX cycle; and selectively performing or dropping a feedback transmission associated with the monitoring based at least in part on the overlap between the second subset of SPS occasions and the inactive period of the DTX cycle.

Aspect 2: The method of aspect 1, wherein selectively performing or dropping the feedback transmission comprises: dropping the feedback transmission based at least in part on the overlap between the second subset of SPS occasions and the inactive period.

Aspect 3: The method of any of aspects 1 through 2, wherein selectively performing or dropping the feedback transmission comprises: dropping the feedback transmission based at least in part on a numerical quantity of SPS occasions in the first subset of SPS occasions overlapping with the active period of the DTX cycle failing to satisfy a threshold.

Aspect 4: The method of any of aspects 1 through 3, wherein selectively performing or dropping the feedback transmission comprises: performing the feedback transmission based at least in part on the overlap between the first subset of SPS occasions and the active period of the DTX cycle, the feedback transmission performed after a last SPS occasion.

Aspect 5: The method of aspect 4, wherein the last SPS occasion comprises a sequentially last scheduled SPS occasion in the set of SPS occasions.

Aspect 6: The method of any of aspects 4 through 5, wherein the last SPS occasion comprises a last SPS occasion of the first subset of SPS occasions overlapping with the active period of the DTX cycle.

Aspect 7: The method of any of aspects 1 through 6, wherein selectively performing or dropping the feedback transmission comprises: performing the feedback transmission during an uplink occasion occurring during the second subset of SPS occasions based at least in part on a third subset of SPS occasions in the set of SPS occasions scheduled during a second active period of the DTX cycle, the second active period following the inactive period of the DTX cycle in the time domain.

Aspect 8: The method of aspect 7, wherein performing the feedback transmission is based at least in part on a numerical quantity of SPS occasions in the first subset of SPS occasions, a time offset between the uplink occasion and a start of the second active period, or both.

Aspect 9: A method for wireless communications at a UE, comprising: selectively monitoring, based at least in part on an active period of a DTX cycle of a network entity, for a DCI message associated with activating or deactivating the DTX cycle of a network entity, the DCI message comprising a group common DCI message; and communicating with the network entity according to the DTX cycle based at least in part on the selectively monitoring.

Aspect 10: The method of aspect 9, wherein the selectively monitoring comprises: monitoring for the DCI message during the active period of the DTX cycle.

Aspect 11: The method of any of aspects 9 through 10, wherein the selectively monitoring comprises: monitoring for the group common DCI message outside of the active period and during an inactive period of the DTX cycle.

Aspect 12: The method of any of aspects 9 through 11, wherein the selectively monitoring comprises: refraining from monitoring for the DCI message during one or more monitoring occasions occurring outside of the active period and during an inactive period of the DTX cycle.

Aspect 13: The method of any of aspects 9 through 12, further comprising: receiving a signal indicating that the UE is to refrain from monitoring for the DCI message during one or more monitoring occasions occurring outside of the active period and during an inactive period of the DTX cycle.

Aspect 14: The method of any of aspects 9 through 13, further comprising: transmitting a UE capability message indicating support for activating or deactivating the DTX cycle via the DCI message.

Aspect 15: The method of aspect 14, wherein the support comprises support for refraining from monitoring for the DCI message outside of the active period and during an inactive period of the DTX cycle.

Aspect 16: A method for wireless communications at a network entity, comprising: performing, during a set of SPS occasions of a UE, one or more downlink transmissions to the UE, wherein a first subset of SPS occasions overlaps in a time domain with an active period of a DTX cycle of the network entity and a second subset of SPS occasions overlaps in the time domain with an inactive period of the DTX cycle; and selectively receiving or dropping a feedback transmission from the UE associated with the one or more downlink transmissions based at least in part on the overlap between the second subset of SPS occasions and the inactive period of the DTX cycle.

Aspect 17: The method of aspect 16, wherein selectively receiving or dropping the feedback transmission comprises: dropping the feedback transmission based at least in part on the overlap between the second subset of SPS occasions and the inactive period.

Aspect 18: The method of any of aspects 16 through 17, wherein selectively receiving or dropping the feedback transmission comprises: dropping the feedback transmission based at least in part on a numerical quantity of SPS occasions in the first subset of SPS occasions overlapping with the active period of the DTX cycle failing to satisfy a threshold.

Aspect 19: The method of any of aspects 16 through 18, wherein selectively receiving or dropping the feedback transmission comprises: receiving the feedback transmission based at least in part on the overlap between the first subset of SPS occasions and the active period of the DTX cycle, the feedback transmission performed after a last SPS occasion.

Aspect 20: The method of aspect 19, wherein the last SPS occasion comprises a sequentially last scheduled SPS occasion in the set of SPS occasions.

Aspect 21: The method of any of aspects 19 through 20, wherein the last SPS occasion comprises a last SPS occasion of the first subset of SPS occasions overlapping with the active period of the DTX cycle.

Aspect 22: The method of any of aspects 16 through 21, wherein selectively receiving or dropping the feedback transmission comprises: receiving the feedback transmission during an uplink occasion occurring during the second subset of SPS occasions based at least in part on a third subset of SPS occasions in the set of SPS occasions scheduled during a second active period of the DTX cycle, the second active period following the inactive period of the DTX cycle in the time domain.

Aspect 23: The method of aspect 22, wherein receiving the feedback transmission is based at least in part on a numerical quantity of SPS occasions in the first subset of SPS occasions, a time offset between the uplink occasion and a start of the second active period, or both.

Aspect 24: A method for wireless communications at a network entity, comprising: selectively transmitting, to a UE and based at least in part on an active period of a DTX cycle of the network entity, a DCI message associated with activating or deactivating the DTX cycle, the DCI message comprising a group common DCI message; and communicating with the UE according to the DTX cycle based at least in part on the selectively transmitting.

Aspect 25: The method of aspect 24, wherein the selectively transmitting comprises: transmitting the DCI message during the active period of the DTX cycle.

Aspect 26: The method of any of aspects 24 through 25, wherein the selectively transmitting comprises: transmitting the group common DCI message outside of the active period and during an inactive period of the DTX cycle.

Aspect 27: The method of any of aspects 24 through 26, wherein the selective transmitting comprises: refraining from transmitting the DCI message during one or more monitoring occasions occurring outside of the active period and during an inactive period of the DTX cycle.

Aspect 28: The method of any of aspects 24 through 27, further comprising:

transmitting a signal indicating that the UE is to refrain from monitoring for the DCI message during one or more monitoring occasions occurring outside of the active period and during an inactive period of the DTX cycle.

Aspect 29: The method of any of aspects 24 through 28, further comprising:

receiving a UE capability message indicating support for activating or deactivating the DTX cycle via the DCI message.

Aspect 30: The method of aspect 29, wherein the support comprises support for refraining from monitoring for the DCI message outside of the active period and during an inactive period of the DTX cycle.

Aspect 31: An apparatus for wireless communications at a UE, comprising at least one processor; at least one memory coupled with the at least one processor; and

instructions stored in the at least one memory and executable by the at least one processor to cause the apparatus to perform a method of any of aspects 1 through 8.

Aspect 32: An apparatus for wireless communications at a UE, comprising at least one means for performing a method of any of aspects 1 through 8.

Aspect 33: A non-transitory computer-readable medium storing code for wireless communications at a UE, the code comprising instructions executable by one or more processors to perform a method of any of aspects 1 through 8.

Aspect 34: An apparatus for wireless communications at a UE, comprising at least one processor; at least one memory coupled with the at least one processor; and instructions stored in the at least one memory and executable by the at least one processor to cause the apparatus to perform a method of any of aspects 9 through 15.

Aspect 35: An apparatus for wireless communications at a UE, comprising at least one means for performing a method of any of aspects 9 through 15.

Aspect 36: A non-transitory computer-readable medium storing code for wireless communications at a UE, the code comprising instructions executable by one or more processors to perform a method of any of aspects 9 through 15.

Aspect 37: An apparatus for wireless communications at a network entity, comprising at least one processor; at least one memory coupled with the at least one processor; and instructions stored in the at least one memory and executable by the at least one processor to cause the apparatus to perform a method of any of aspects 16 through 23.

Aspect 38: An apparatus for wireless communications at a network entity, comprising at least one means for performing a method of any of aspects 16 through 23.

Aspect 39: A non-transitory computer-readable medium storing code for wireless communications at a network entity, the code comprising instructions executable by one or more processors to perform a method of any of aspects 16 through 23.

Aspect 40: An apparatus for wireless communications at a network entity, comprising at least one processor; at least one memory coupled with the at least one processor; and instructions stored in the at least one memory and executable by the at least one processor to cause the apparatus to perform a method of any of aspects 24 through 30.

Aspect 41: An apparatus for wireless communications at a network entity, comprising at least one means for performing a method of any of aspects 24 through 30.

Aspect 42: A non-transitory computer-readable medium storing code for wireless communications at a network entity, the code comprising instructions executable by one or more processors to perform a method of any of aspects 24 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors;
one or more memories coupled with the one or more processors; and
instructions stored in the one or more memories and executable by the one or more processors to cause the apparatus to:
monitor a set of semi-persistent scheduling occasions associated with downlink transmissions from a network entity, wherein a first subset of semi-persistent scheduling occasions overlaps in a time domain with an active period of a discontinuous transmission cycle of the network entity and a second subset of semi-persistent scheduling occasions overlaps in the time domain with an inactive period of the discontinuous transmission cycle; and
selectively perform or drop a feedback transmission associated with the monitoring based at least in part on the overlap between the second subset of semi-persistent scheduling occasions and the inactive period of the discontinuous transmission cycle.

2. The apparatus of claim 1, wherein the instructions to selectively perform or drop the feedback transmission are executable by the one or more processors to cause the apparatus to:
drop the feedback transmission based at least in part on the overlap between the second subset of semi-persistent scheduling occasions and the inactive period.

3. The apparatus of claim 1, wherein the instructions to selectively perform or drop the feedback transmission are executable by the one or more processors to cause the apparatus to:
drop the feedback transmission based at least in part on a numerical quantity of semi-persistent scheduling occasions in the first subset of semi-persistent scheduling occasions overlapping with the active period of the discontinuous transmission cycle failing to satisfy a threshold.

4. The apparatus of claim 1, wherein the instructions to selectively perform or drop the feedback transmission are executable by the one or more processors to cause the apparatus to:
perform the feedback transmission based at least in part on the overlap between the first subset of semi-persistent scheduling occasions and the active period of the discontinuous transmission cycle, the feedback transmission performed after a last semi-persistent scheduling occasion.

5. The apparatus of claim 4, wherein the last semi-persistent scheduling occasion comprises a sequentially last scheduled semi-persistent scheduling occasion in the set of semi-persistent scheduling occasions.

6. The apparatus of claim 4, wherein the last semi-persistent scheduling occasion comprises a last semi-persistent scheduling occasion of the first subset of semi-persistent scheduling occasions overlapping with the active period of the discontinuous transmission cycle.

7. The apparatus of claim 1, wherein the instructions to selectively perform or drop the feedback transmission are executable by the one or more processors to cause the apparatus to:
perform the feedback transmission during an uplink occasion occurring during the second subset of semi-persistent scheduling occasions based at least in part on a third subset of semi-persistent scheduling occasions in the set of semi-persistent scheduling occasions scheduled during a second active period of the discontinuous transmission cycle, the second active period following the inactive period of the discontinuous transmission cycle in the time domain.

8. The apparatus of claim 7, wherein performing the feedback transmission is based at least in part on a numerical quantity of semi-persistent scheduling occasions in the first subset of semi-persistent scheduling occasions, a time offset between the uplink occasion and a start of the second active period, or both.

9. An apparatus for wireless communications at a user equipment (UE), comprising:
one or more processors;
one or more memories coupled with the one or more processors; and
instructions stored in the one or more memories and executable by the one or more processors to cause the apparatus to:
selectively monitor, based at least in part on an active period of a discontinuous transmission cycle of a network entity, for a downlink control information message associated with activating or deactivating the discontinuous transmission cycle of a network entity, the downlink control information message comprising a group common downlink control information message; and
communicate with the network entity according to the discontinuous transmission cycle based at least in part on the selectively monitoring.

10. The apparatus of claim 9, wherein the instructions to selectively monitor are executable by the one or more processors to cause the apparatus to:
monitor for the downlink control information message during the active period of the discontinuous transmission cycle.

11. The apparatus of claim 9, wherein the instructions to selectively monitor are executable by the one or more processors to cause the apparatus to:
monitor for the group common downlink control information message outside of the active period and during an inactive period of the discontinuous transmission cycle.

12. The apparatus of claim 9, wherein the instructions to selectively monitor are executable by the one or more processors to cause the apparatus to:
refrain from monitoring for the downlink control information message during one or more monitoring occasions occurring outside of the active period and during an inactive period of the discontinuous transmission cycle.

13. The apparatus of claim 9, wherein the instructions are further executable by the one or more processors to cause the apparatus to:
receive a signal indicating that the UE is to refrain from monitoring for the downlink control information message during one or more monitoring occasions occurring outside of the active period and during an inactive period of the discontinuous transmission cycle.

14. The apparatus of claim 9, wherein the instructions are further executable by the one or more processors to cause the apparatus to:
transmit a UE capability message indicating support for activating or deactivating the discontinuous transmission cycle via the downlink control information message.

15. The apparatus of claim 14, wherein the support comprises support for refraining from monitoring for the downlink control information message outside of the active period and during an inactive period of the discontinuous transmission cycle.

16. A method for wireless communications at a user equipment (UE), comprising:
monitoring a set of semi-persistent scheduling occasions associated with downlink transmissions from a network entity, wherein a first subset of semi-persistent scheduling occasions overlaps in a time domain with an active period of a discontinuous transmission cycle of the network entity and a second subset of semi-persistent scheduling occasions overlaps in the time domain with an inactive period of the discontinuous transmission cycle; and
selectively performing or dropping a feedback transmission associated with the monitoring based at least in part on the overlap between the second subset of semi-persistent scheduling occasions and the inactive period of the discontinuous transmission cycle.

17. The method of claim 16, wherein selectively performing or dropping the feedback transmission comprises:
dropping the feedback transmission based at least in part on the overlap between the second subset of semi-persistent scheduling occasions and the inactive period.

18. The method of claim 16, wherein selectively performing or dropping the feedback transmission comprises:
dropping the feedback transmission based at least in part on a numerical quantity of semi-persistent scheduling occasions in the first subset of semi-persistent scheduling occasions overlapping with the active period of the discontinuous transmission cycle failing to satisfy a threshold.

19. The method of claim 16, wherein selectively performing or dropping the feedback transmission comprises:
performing the feedback transmission based at least in part on the overlap between the first subset of semi-persistent scheduling occasions and the active period of the discontinuous transmission cycle, the feedback transmission performed after a last semi-persistent scheduling occasion.

20. The method of claim 19, wherein the last semi-persistent scheduling occasion comprises a sequentially last scheduled semi-persistent scheduling occasion in the set of semi-persistent scheduling occasions.

21. The method of claim 19, wherein the last semi-persistent scheduling occasion comprises a last semi-persistent scheduling occasion of the first subset of semi-persistent scheduling occasions overlapping with the active period of the discontinuous transmission cycle.

22. The method of claim 16, wherein selectively performing or dropping the feedback transmission comprises:
performing the feedback transmission during an uplink occasion occurring during the second subset of semi-persistent scheduling occasions based at least in part on a third subset of semi-persistent scheduling occasions in the set of semi-persistent scheduling occasions scheduled during a second active period of the discontinuous transmission cycle, the second active period following the inactive period of the discontinuous transmission cycle in the time domain.

23. The method of claim 22, wherein performing the feedback transmission is based at least in part on a numerical quantity of semi-persistent scheduling occasions in the first subset of semi-persistent scheduling occasions, a time offset between the uplink occasion and a start of the second active period, or both.

24. A method for wireless communications at a user equipment (UE), comprising:
selectively monitoring, based at least in part on an active period of a discontinuous transmission cycle of a network entity, for a downlink control information message associated with activating or deactivating the discontinuous transmission cycle of a network entity, the downlink control information message comprising a group common downlink control information message; and
communicating with the network entity according to the discontinuous transmission cycle based at least in part on the selectively monitoring.

25. The method of claim 24, wherein the selectively monitoring comprises:
monitoring for the downlink control information message during the active period of the discontinuous transmission cycle.

26. The method of claim 24, wherein the selectively monitoring comprises:
monitoring for the group common downlink control information message outside of the active period and during an inactive period of the discontinuous transmission cycle.

27. The method of claim 24, wherein the selectively monitoring comprises:
refraining from monitoring for the downlink control information message during one or more monitoring occasions occurring outside of the active period and during an inactive period of the discontinuous transmission cycle.

28. The method of claim 24, further comprising:
receiving a signal indicating that the UE is to refrain from monitoring for the downlink control information message during one or more monitoring occasions occurring outside of the active period and during an inactive period of the discontinuous transmission cycle.

29. The method of claim 24, further comprising:
transmitting a UE capability message indicating support for activating or deactivating the discontinuous transmission cycle via the downlink control information message.

30. The method of claim 29, wherein the support comprises support for refraining from monitoring for the downlink control information message outside of the active period and during an inactive period of the discontinuous transmission cycle.
